(19) United States
(12) Patent Application Publication
(10) Pub. No.: US 2025/0218191 A1
(43) Pub. Date: Jul. 3, 2025

(54) TRAVEL ENVIRONMENT DECISION APPARATUS, VEHICLE, TRAVEL ENVIRONMENT DECISION METHOD, AND NON-TRANSITORY COMPUTER READABLE MEDIUM

(71) Applicant: NEC Corporation, Minato-ku Tokyo (JP)

(72) Inventor: Masataka NISHIDA, Tokyo (JP)

(73) Assignee: NEC Corporation, Minato-ku Tokyo (JP)

(21) Appl. No.: 18/852,607

(22) PCT Filed: Apr. 25, 2022
(86) PCT No.: PCT/JP2022/018677

§ 371 Date: Sep. 30, 2024

(51) Int. Cl. G06V 20/56; G06V 10/25

(52) U.S. Cl. CPC G06V 20/56; G06V 10/25

(57) ABSTRACT

A travel environment decision apparatus (100) includes an image acquisition unit (105), an analysis unit (106), and a decision unit (107). The image acquisition unit (105) acquires a photographed image to be acquired by photographing by a photographing apparatus installed in a vehicle. The analysis unit (106) performs analysis processing with respect to the photographed image, and determines a first region being a region associated with the sky in the photographed image. The decision unit (107) decides whether the vehicle is present within a structure, based on the first region.

### TECHNICAL FIELD

The present invention relates to a travel environment decision apparatus, a vehicle, a travel environment decision method, and a storage medium.

### BACKGROUND ART

A vehicle described in Patent Document 1 includes a camera and a detection device for detecting a tunnel. The camera described in Patent Document 1 is able to photograph at least one image region around the vehicle, and is disposed at a front of the vehicle. The image region includes a plurality of pixels. The tunnel detection device described in Patent Document 1 is designed in such a way as to decide an average luminance of at least one image region. The tunnel detection device includes a device for detecting a characteristic, and is able to acquire a difference in a luminance between pixels being different from each other by using the device. Therefore, the tunnel detection device is able to detect, in at least one image region, a characteristic characterized by a drastic change in a luminance.

An auto light system described in Patent Document 2 is a system that is loaded in a vehicle, and configured to capture a travel environment (mainly, a scene ahead) of the vehicle during traveling, and automatically control turning on and off of a light, based on the captured image. In the auto light system, an image of a wider range (angle of view) in a vertical direction is acquired by a camera using a wide-angle lens of a special type. Further, an image within a vehicle compartment is captured in a lower region within a captured image by installing a prism at a lower portion of a windshield within the vehicle compartment. This allows a captured image by the camera to become an image in a sufficiently wide range from a region (region in which a structure and the like are hardly likely to be captured) in front of the vehicle and high above the sky, as a higher position, to a region within the vehicle compartment, as a lower position.

Then, within the captured image, four regions, namely, a front and above brightness decision region, a front and midair brightness decision region, a front and far brightness decision region, and a vehicle compartment brightness decision region are set. Brightness and darkness are decided for each decision region, and decision is made as to how to control a vehicle light, based on the decision result.

An object candidate region detection apparatus described in Patent Document 3 detects, from an input image photographed by a camera, a region with a possibility that a specific object is present, as an object candidate region. The object candidate region detection apparatus includes a reference pattern storage unit, a background region dividing unit, a to-be-decided region cutting-out unit, a reference pattern selection unit, and a detection unit.

The reference pattern storage unit described in Patent Document 3 stores, regarding a background of an input image, a plurality of reference patterns being different for each of a road region, and a region other than a road. The background region dividing unit described in Patent Document 3 divides an input image currently photographed by a camera, regarding a background, into each of a road region, and a region other than a road. The to-be-decided region cutting-out unit described in Patent Document 3 cuts out a to-be-decided region from an input image currently photographed by a camera.

The reference pattern selection unit described in Patent Document 3 selects, from among a plurality of reference patterns, a reference pattern according to a background region depending on from which one of background regions that are a road region and a region other than a road, a to-be-decided region is cut out. The detection unit described in Patent Document 3 detects an object candidate region from a to-be-decided region by comparing a selected reference pattern with the to-be-decided region.

Non-Patent Document 1 describes region recognition (also referred to as region division, segmentation, and the like) being one of techniques for image recognition. The region recognition is a technique of estimating a type of a subject represented in a region, for each region included in an image, by setting the image as an input.

### RELATED DOCUMENT

### Patent Document

Patent Document 1: Japanese Patent Application Publication (Translation of PCT Application) No. 2014-517388

Patent Document 2: Japanese Patent Application Publication No. 2009-255722

Patent Document 3: Japanese Patent Application Publication No. 2007-328630

### Non-Patent Document

Non-Patent Document 1: S. Schulter et al., “Learning to Look around Objects for Top-View Representations of Outdoor Scenes”, ECCV, 2018, pp. 787 to 802

### DISCLOSURE OF THE INVENTION

### Technical Problem

In the technique described in Patent Document 1, a tunnel is detected based on a difference in a luminance of a pixel. However, in a case where it is detected that a vehicle is present within a tunnel, based only on a luminance of a pixel, it may be erroneously detected that the vehicle is present within the tunnel because there are various photographing environments of a camera.

In the technique described in Patent Document 2, presence of a vehicle within a tunnel is recognized based on brightness of each decision region within a captured image. However, since brightness of a decision region is a value to be acquired based on a luminance of a pixel, also in the technique described in Patent Document 2, similarly to the technique described in Patent Document 1, presence of a vehicle within a tunnel may be erroneously recognized. Further, in the technique described in Patent Document 2, a camera using a wide-angle lens of a special type is required, and recognition that a vehicle is present within a tunnel may become difficult in a captured image using a camera of a general angle of view.

Patent Document 3 describes that an input image currently photographed by a camera is divided, regarding a background, into each of a road region, and a region other than a road. Further, Non-Patent Document 1 describes an example of region recognition. However, both of Patent Document 3 and Non-Patent Document 1 do not disclose a technique for deciding whether a vehicle is present within a structure such as a tunnel.

One example of an object of the present invention is, in view of the above-described problem, to provide a travel environment decision apparatus, a vehicle, a travel environment decision method, and a storage medium that solve a task of accurately deciding whether a vehicle is present within a structure.

### Solution to Problem

One aspect of the present invention provides a travel environment decision apparatus including:
an image acquisition unit that acquires a photographed image to be acquired by photographing by a photographing apparatus installed in a vehicle;
an analysis unit that performs analysis processing with respect to the photographed image, and determines a first region being a region associated with the sky in the photographed image; and
a decision unit that decides whether the vehicle is present within a structure, based on the first region.

One aspect of the present invention provides a vehicle including:
the above-described travel environment decision apparatus; and
the photographing apparatus that is installed in the vehicle, and generates the photographed image by photographing.

One aspect of the present invention provides a travel environment decision method including,
by a computer:
acquiring a photographed image to be acquired by photographing by a photographing apparatus installed in a vehicle;
performing analysis processing with respect to the photographed image, and determining a first region being a region associated with the sky in the photographed image; and
deciding whether the vehicle is present within a structure, based on the first region.

One aspect of the present invention provides a storage medium storing a program for causing a computer to execute:
acquiring a photographed image to be acquired by photographing by a photographing apparatus installed in a vehicle;
performing analysis processing with respect to the photographed image, and determining a first region being a region associated with the sky in the photographed image; and
deciding whether the vehicle is present within a structure, based on the first region.

### Advantageous Effects of Invention

According to one aspect of the present invention, it becomes possible to provide a travel environment decision apparatus, a vehicle, a travel environment decision method, and a storage medium that solve a task of accurately deciding whether a vehicle is present within a structure.

### BRIEF DESCRIPTION OF THE DRAWINGS

FIG. 1 is a diagram illustrating an overview of a travel environment decision apparatus according to an example embodiment 1.

FIG. 2 is a diagram illustrating an overview of a vehicle according to the example embodiment 1.

FIG. 3 is a flowchart illustrating an overview of travel environment decision processing according to the example embodiment 1.

FIG. 4 is a diagram illustrating a detailed configuration example of the vehicle according to the example embodiment 1.

FIG. 5 is a diagram illustrating a physical configuration example of the travel environment decision apparatus according to the example embodiment 1.

FIG. 6 is a flowchart illustrating one example of the travel environment decision processing according to the example embodiment 1.

FIG. 7 is a diagram illustrating a first example of a photographed image.

FIG. 8 is a diagram illustrating a second example of a photographed image.

FIG. 9 is a diagram illustrating a functional configuration example of a travel environment decision apparatus according to an example embodiment 2.

FIG. 10 is a flowchart illustrating one example of travel environment decision processing according to the example embodiment 2.

FIG. 11 is a flowchart illustrating a detailed example of decision processing according to the example embodiment 2.

### EXAMPLE EMBODIMENT

Hereinafter, example embodiments according to the present invention are described by using the drawings. Note that, in all drawings, a similar constituent element is indicated by a similar reference sign, and description thereof is omitted as necessary.

### Example Embodiment 1

### Overview

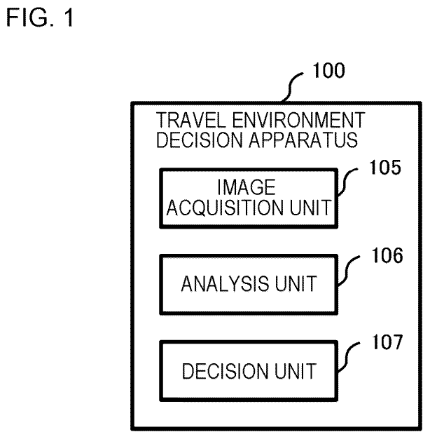

FIG. 1 is a diagram illustrating an overview of a travel environment decision apparatus 100 according to an example embodiment 1. The travel environment decision apparatus 100 includes an image acquisition unit 105, an analysis unit 106, and a decision unit 107.

The image acquisition unit 105 acquires a photographed image to be acquired by photographing by a photographing apparatus installed in a vehicle. The analysis unit 106 performs analysis processing with respect to the photographed image, and determines a first region being a region associated with the sky in the photographed image. The decision unit 107 decides whether the vehicle is present within a structure, based on the first region.

According to the travel environment decision apparatus 100, it becomes possible to accurately decide whether a vehicle is present within a structure.

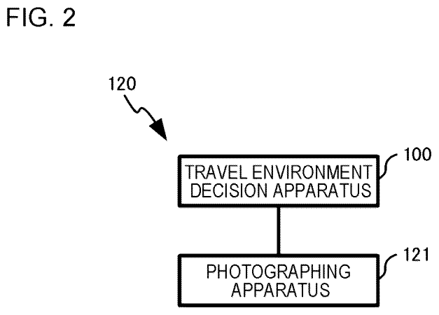

FIG. 2 is a diagram illustrating an overview of a vehicle 120 according to the example embodiment 1. The vehicle 120 includes the travel environment decision apparatus 100 and a photographing apparatus 121. The photographing apparatus 121 is installed in a vehicle, and generates a photographed image by photographing.

According to the vehicle 120, it becomes possible to accurately decide whether the vehicle 120 is present within a structure.

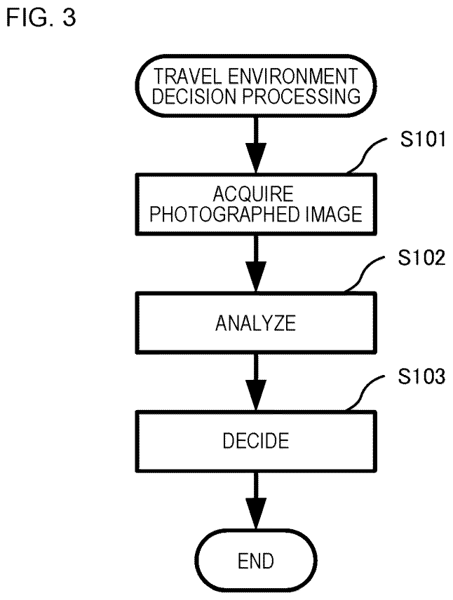

FIG. 3 is a flowchart illustrating an overview of travel environment decision processing according to the example embodiment 1.

The image acquisition unit 105 acquires a photographed image to be acquired by photographing by the photographing apparatus 121 installed in the vehicle 120 (step S101). The analysis unit 106 performs analysis processing with respect to the photographed image, and determines a first region being a region associated with the sky in the photographed image (step S102). The decision unit 107 decides whether the vehicle 120 is present within a structure, based on the first region (step S103).

According to the travel environment decision method, it becomes possible to accurately decide whether a vehicle is present within a structure.

### Details

Hereinafter, a detailed example of the vehicle 120 according to the example embodiment 1 is described.

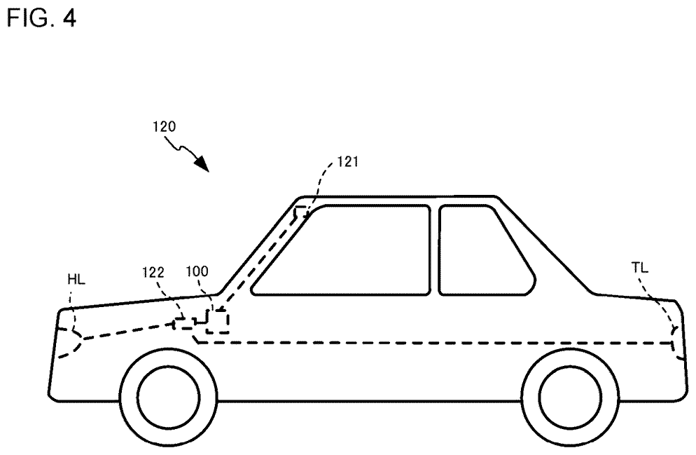

FIG. 4 is a diagram illustrating a detailed configuration example of the vehicle 120 according to the present example embodiment. The vehicle 120 is, for example, a standard car, a truck, a bus, or the like. Note that, the vehicle 120 may be a motorcycle, a bicycle, or the like.

The vehicle 120 according to the present example embodiment includes the photographing apparatus 121, a vehicle control apparatus 122, and the travel environment decision apparatus 100. The photographing apparatus 121, the vehicle control apparatus 122, and the travel environment decision apparatus 100 are connected to one another in such a way as to be able to mutually transmit and receive information via a communication line configured by wired connection, wireless connection, or combining these.

The photographing apparatus 121 is, for example, a camera, or a terminal apparatus such as a smartphone including a photographing function. The photographing apparatus 121 is installed in the vehicle 120 in such a way as to photograph surroundings of the vehicle 120. FIG. 4 illustrates an example in which the photographing apparatus 121 is installed in such a way as to photograph a front of the vehicle 120. The photographing apparatus 121 according to the present example embodiment generates a photographed image in which a front of the vehicle 120 is photographed. An angle of view of the photographing apparatus 121 may be an angle of view of a camera to be generally loaded in a vehicle, a camera included in a general terminal apparatus, or the like, and is, for example, from 80 to 110 degrees. Note that, the angle of view of the photographing apparatus 121 is not limited thereto.

Note that, the photographing apparatus 121 may be installed in such a way as to photograph, for example, a rear or a side of the vehicle 120, in addition to a front of the vehicle 120, and generate a photographed image in which the rear or the side of the vehicle 120 is photographed. Further, FIG. 4 illustrates an example in which the photographing apparatus 121 is installed within a vehicle compartment of the vehicle 120, however, as far as the photographing apparatus 121 is installed in the vehicle 120, an installation place of the photographing apparatus 121 is not limited to within a vehicle compartment.

The vehicle control apparatus 122 is an electronic control unit (ECU) or the like. The vehicle control apparatus 122 controls the vehicle 120.

For example, in a case where the vehicle 120 includes an autonomous driving function, the vehicle control apparatus 122 controls traveling of the vehicle 120 by using map information, current position information, and the like. The vehicle control apparatus 122 acquires the current position information, for example, by using a global positioning system (GPS).

For example, in a case where the vehicle 120 includes an automatic lighting function of controlling an exterior vehicle light that emits light to an outside of the vehicle 120, the vehicle control apparatus 122 controls turning on and off of the exterior vehicle light. The exterior vehicle light is, for example, one or a plurality of a headlight HL, a tail lamp (also referred to as a taillight, a tail light, and the like) TL, and a vehicle width light (not illustrated), and the like.

### Functional Configuration Example of Travel Environment Decision Apparatus 100

The travel environment decision apparatus 100 according to the present example embodiment is an apparatus for deciding an environment in which the vehicle 120 travels. For example, the travel environment decision apparatus 100 decides, as a travel environment of the vehicle 120, whether the vehicle 120 is present within a tunnel provided in a highway, a general road, or the like, or whether the vehicle 120 is present within a structure such as an indoor parking lot.

As described above with reference to FIG. 1, the travel environment decision apparatus 100 functionally includes the image acquisition unit 105, the analysis unit 106, and the decision unit 107.

The image acquisition unit 105 acquires, from the photographing apparatus 121, a photographed image generated by photographing by the photographing apparatus 121 via a communication line.

The analysis unit 106 performs analysis processing with respect to the photographed image acquired by the image acquisition unit 105, and determines various regions included in the photographed image.

For example, region recognition (also referred to as region division, segmentation, or the like) being one of techniques for image recognition may be applied to analysis processing to be performed by the analysis unit 106 for determining various regions included in a photographed image. The region recognition is a technique of estimating a type of a subject represented in a region, for each region included in an image, by setting the image as an input. As an example of region recognition as described above, there is a technique described in Non-Patent Document 1.

Further, the analysis unit 106 may determine various regions included in a photographed image by using a pre-learned learning model by machine learning. In this case, for example, the analysis unit 106 determines various regions by using a learning model in which a photographed image is input, and region information for dividing into each region included in the photographed image is output. In this case, at a learning time of the learning model, it is preferable to perform supervised learning in which a photographed image with a type of a subject being attached to each region of the photographed image is set as training data.

Generally, a road along which the vehicle 120 travels includes various roads, for example, such as a highway and a general road. For example, while, in a general road, a sidewalk for a pedestrian, and a roadside tree are highly likely to be present near the road, in a highway, a sidewalk for a pedestrian, and a roadside tree are less likely to be present on the road. In this way, a subject included in a photographed image differs according to an attribute of a road. Therefore, the analysis unit 106 may hold a plurality of pre-learned learning models according to an attribute of a road.

Then, the analysis unit 106 may determine various regions included in a photographed image such as a first region by using a learning model, among the plurality of learning models, according to an attribute of a road along which the vehicle 120 travels. In this case, a type of a road along which the vehicle 120 travels may be acquired, for example, from the vehicle control apparatus 122. For example, the vehicle control apparatus 122 may discriminate a type of a road from position information of the vehicle 120 and map information, may discriminate a type of a road from a traveling velocity of the vehicle 120, or may discriminate a type of a road from an analysis result of a photographed image.

The analysis unit 106 determines, for example, a first region by using a technique as described above. As described above, the first region is a region associated with the sky in a photographed image.

Further, for example, a region to be determined by the analysis unit 106 includes a reference region. The reference region is a region above a position associated with a road in a photographed image. In the present example embodiment, the reference region is a first region, and a second region to be described later, in a region above a position associated with a road in a photographed image.

The position associated with a road is, for example, a position of an upper end of a road in a photographed image. The position of the upper end of a road in a photographed image is, for example, determined as a position of a vanishing point on a road in the photographed image.

To derive a vanishing point, the analysis unit 106 determines, from a photographed image, a line associated with a line extending in parallel to an actual road along which the vehicle 120 travels. The line extending in parallel to the actual road is, for example, a line associated with both side ends of a road, a white line on a road, a yellow line on a road, and the like. Then, the analysis unit 106 derives a vanishing point on a road in the photographed image by using the determined line.

Furthermore, for example, the analysis unit 106 determines a second region being a region associated with a subject of a predetermined type other than the sky in a photographed image.

The second region includes, for example, a region associated with at least one of an obstacle and a structure. The obstacle includes another vehicle around the vehicle 120. The structure may include at least one of a tunnel and an indoor parking lot. The structure may further include a building around a road.

Note that, the second region is not limited to an obstacle and a structure, and may include, for example, one or a plurality of a road, a person, a traffic light, a white line, a yellow line, a street post (street light), a motorcycle, a road sign, a stop line, a pedestrian crossing, a parking lot (parking space in a road shoulder), paint on a street, a sidewalk, a driveway (vehicle passage way on a sidewalk connecting a roadway, and a facility or the like), a railway line, a tree, a plant, and others.

The decision unit 107 decides whether the vehicle 120 is present within a structure, based on a reference region and a first region decided by the analysis unit 106. A structure through which the vehicle 120 travels inside is typically a tunnel, a building or a structure including an indoor parking lot, and the like.

So far, a functional configuration example of the travel environment decision apparatus 100 according to the example embodiment 1 has been described. Hereinafter, a physical configuration example of the travel environment decision apparatus 100 according to the example embodiment 1 is described.

### Physical Configuration Example of Travel Environment Decision Apparatus 100

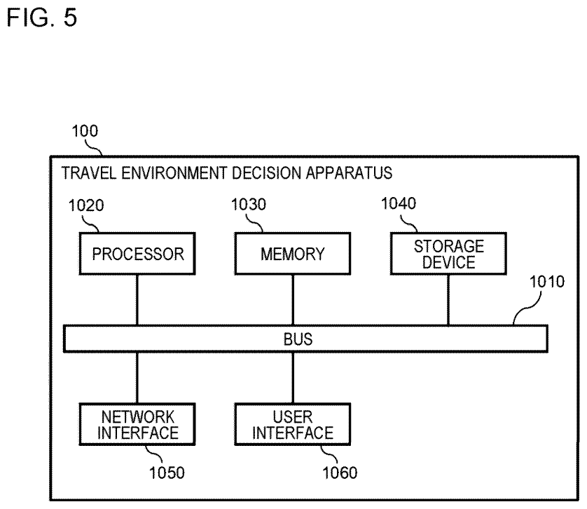

FIG. 5 is a diagram illustrating a physical configuration example of the travel environment decision apparatus 100 according to the present example embodiment. The travel environment decision apparatus 100 physically includes, for example, a bus 1010, a processor 1020, a memory 1030, a storage device 1040, a network interface 1050, and a user interface 1060.

The bus 1010 is a data transmission path along which the processor 1020, the memory 1030, the storage device 1040, the network interface 1050, and the user interface 1060 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module achieving each functional unit of the travel environment decision apparatus 100. Each functional unit associated with a program module is achieved by causing the processor 1020 to read each program module in the memory 1030 and execute the program module.

The network interface 1060 is an interface for connecting the travel environment decision apparatus 100 to a communication line.

The user interface 1050 is, for example, an interface for allowing a user to connect a terminal or the like for performing various settings and the like with respect to the travel environment decision apparatus 100.

So far, the functional and physical configuration examples of the vehicle 120 according to the example embodiment 1 have been described. Hereinafter, an operation example of the vehicle 120 according to the example embodiment 1 is described.

### Operation Example of Vehicle 120 according to Example Embodiment 1

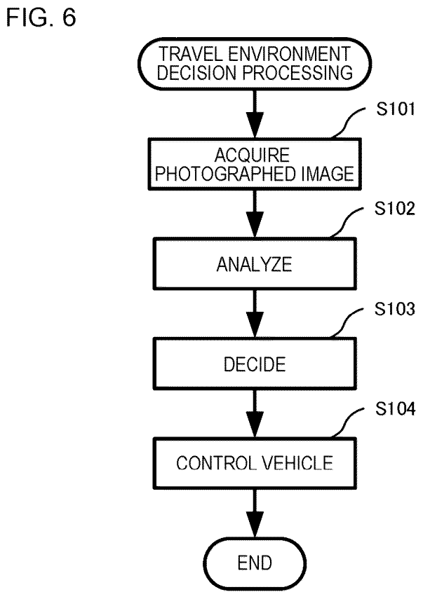

FIG. 6 is a flowchart illustrating one example of travel environment decision processing according to the present example embodiment. The travel environment decision processing is processing for deciding an environment in which the vehicle 120 travels. Environment decision processing is, for example, repeatedly performed during traveling of the vehicle 120. The photographing apparatus 121 photographs a front of the vehicle 120 during traveling of the vehicle 120, and generates a photographed image acquired by the photographing.

The image acquisition unit 105 acquires the photographed image generated in the photographing apparatus 121 (step S101).

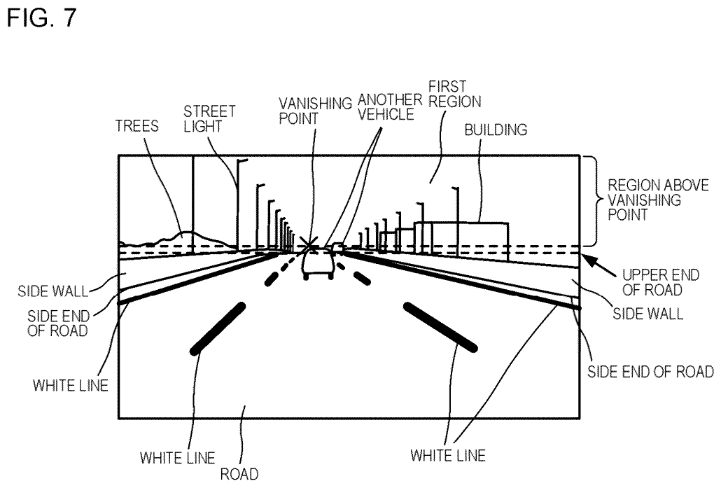

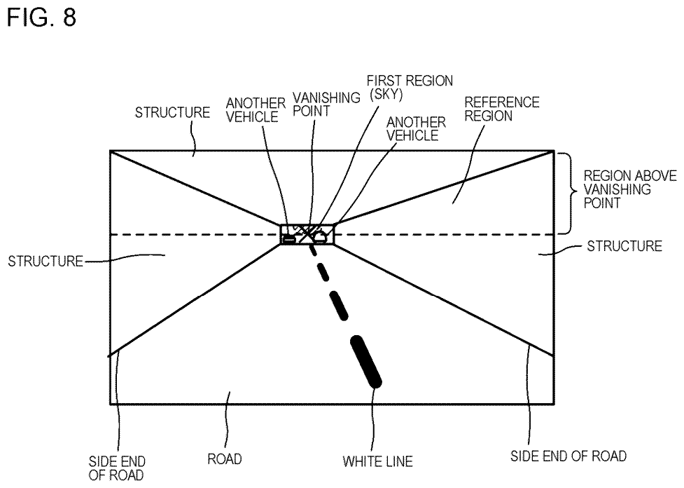

Each of FIGS. 7 and 8 illustrates an example of a photographed image generated in the photographing apparatus 121. FIG. 7 illustrates an example of a photographed image photographed by the photographing apparatus 121 installed in the vehicle 120 traveling outside a tunnel of a highway. FIG. 8 illustrates an example of a photographed image photographed by the photographing apparatus 121 installed in the vehicle 120 traveling inside the tunnel of the highway.

The analysis unit 106 analyzes the photographed image acquired in step S101 (step S102).

Specifically, the analysis unit 106 determines a first region being a region associated with the sky in the photographed image (see FIGS. 7 and 8).

Further, the analysis unit 106 determines a reference region in the photographed image. As described above, the reference region in the present example embodiment is the first region and a second region, in a region above a position associated with a road in the photographed image. As described above, thee second region is a region associated with a subject of a predetermined type other than the sky, however, herein, it is assumed that the second region is an obstacle and a structure.

In a case where a position associated with a road in the photographed image is a vanishing point on a road, in the example of the photographed image illustrated in FIGS. 7 and 8, the analysis unit 106 is the first region and the second region, in a region above a vanishing point on a road in the photographed image.

In the example illustrated in FIG. 7, the second region includes a building being a structure, and another vehicle being an obstacle. In the example illustrated in FIG. 8, the second region includes a tunnel (inner wall) being a structure, and another vehicle being an obstacle.

Note that, the position of the upper end of a road is not limited to a vanishing point on a road, but may be determined by any method. For example, the analysis unit 106 may determine, as the second region, a region associated with a road, and determine, as the upper end of a road, a point located at a top of the photographed image in the region associated with the road (see FIG. 8).

The decision unit 107 decides whether the vehicle 120 is present within a structure, based on the reference region and the first region determined in step S102 (step S103).

An appropriate method may be adopted as the decision method in step S103.

For example, the decision unit 107 may decide whether the vehicle 120 is present within a structure, based on a ratio occupied by the first region in the reference region. Generally, in a case where the vehicle 120 is present within a structure, a ratio occupied by the first region in the reference region is small, as compared with a case where the vehicle 120 is present outside the structure. Therefore, for example, in a case where a ratio occupied by the first region in the reference region is equal to or less than a predetermined threshold value, the decision unit 107 decides that the vehicle 120 is present within a structure. Further, in a case where a ratio occupied by the first region in the reference region is more than the predetermined threshold value, the decision unit 107 decides that the vehicle 120 is not present within the structure.

Further, for example, the decision unit 107 may decide whether the vehicle 120 is present within a structure, based on whether surroundings of the first region are surrounded by the second region in the reference region. As illustrated in FIGS. 7 and 8, in a case where the vehicle 120 is present within a structure, surroundings of the first region are surrounded by the second region, however, in a case where the vehicle 120 is not present within the structure, surroundings of the first region are not surrounded by the second region. Herein, a fact that surroundings of the first region are surrounded by the second region means that the second region is present above the first region and on a side of the first region.

Therefore, for example, in a case where surroundings of the first region are surrounded by the second region in the reference region, the decision unit 107 decides that the vehicle 120 is present within a structure. Further, in a case where surroundings of the first region are not surrounded by the second region in the reference region, the decision unit 107 decides that the vehicle 120 is not present within the structure.

The vehicle control apparatus 122 controls the vehicle 120, based on a decision result in step S103 (step S104).

For example, in a case where the vehicle control apparatus 122 controls autonomous driving of the vehicle 120, for example, the vehicle control apparatus 122 switches a control mode between a normal mode and a structure interior mode.

The normal mode is a control mode to be used outside of a structure. In the normal mode, the vehicle control apparatus 122 controls autonomous driving of the vehicle 120 by using current position information to be acquired by using, for example, a GPS.

The structure interior mode is a control mode to be used within a structure. Generally, in a structure such as a tunnel or an indoor parking lot, accuracy of current position information to be acquired by using the GPS is lowered due to diffuse reflection of a radio wave or the like. Therefore, in the structure interior mode, the vehicle control apparatus 122 controls autonomous driving of the vehicle 120 by using, for example, current position information to be acquired by using self-traveling information including a travel distance, a travel direction, and the like of the vehicle 120, in place of the GPS.

Further, for example, in a daytime or the like when an exterior vehicle light is not turned on outside of a structure, the vehicle control apparatus 122 causes the exterior vehicle light to turn on in a case where the vehicle 120 is present within the structure, and causes the exterior vehicle light to turn off in a case where the vehicle 120 is outside of the structure. Specifically, the vehicle control apparatus 122 causes the exterior vehicle light to turn on during a time when the vehicle 120 is present within a structure.

### Advantageous Effect

According to the present example embodiment, the travel environment decision apparatus 100 includes the image acquisition unit 105, the analysis unit 106, and the decision unit 107. The image acquisition unit 105 acquires a photographed image to be acquired by photographing by a photographing apparatus installed in a vehicle. The analysis unit 106 performs analysis processing with respect to the photographed image, and determines a first region being a region associated with the sky in the photographed image. The decision unit 107 decides whether the vehicle 120 is present within a structure, based on the first region.

This enables to determine, from the photographed image, the first region being a region associated with the sky, and decide whether the vehicle 120 is present within a structure, based on the first region. Therefore, it becomes possible to accurately decide whether the vehicle 120 is present within a structure.

According to the present example embodiment, the analysis unit 106 further determines a reference region in which a predetermined criterion is satisfied in the photographed image. The decision unit 107 decides whether the vehicle 120 is present within a structure, based on the reference region and the first region.

This enables to decide, from the photographed image, whether the vehicle 120 is present within a structure, based on the first region being a region associated with the sky, and the reference region in which the predetermined criterion is satisfied. Therefore, it becomes possible to accurately decide whether the vehicle 120 is present within a structure.

According to the present example embodiment, the reference region is a region above a position associated with a road in the photographed image.

This enables to decide, from the photographed image, whether the vehicle 120 is present within a structure, based on the first region being a region associated with the sky, and the reference region in which the predetermined criterion is satisfied. Therefore, it becomes possible to accurately decide whether the vehicle 120 is present within a structure.

The position associated with a road is a position of a vanishing point on a road in the photographed image.

This enables to decide whether the vehicle 120 is present within a structure, based on the first region being a region associated with the sky, and the reference region being a region above a position of a vanishing point on a road in the photographed image. Therefore, it becomes possible to accurately decide whether the vehicle 120 is present within a structure.

The analysis unit 106 performs analysis processing with respect to the photographed image, determines a second region being a region associated with a subject of a predetermined type other than the sky in the photographed image, and determines, as the reference region, the first region and the second region, in a region above a position associated with a road in the photographed image.

This enables to decide whether the vehicle 120 is present within a structure, based on the first region, and the reference region based on the first region and the second region. Therefore, it becomes possible to accurately decide whether the vehicle 120 is present within a structure.

The second region includes a region associated with at least one of an obstacle and a structure.

This enables to decide whether the vehicle 120 is present within a structure, based on the first region, and the reference region based on the first region and the second region. Therefore, it becomes possible to accurately decide whether the vehicle 120 is present within a structure.

The decision unit 107 decides whether the vehicle 120 is present within a structure, based on a ratio occupied by the first region in the reference region.

This enables to decide whether the vehicle 120 is present within a structure, based on the first region and the reference region. Therefore, it becomes possible to accurately decide whether the vehicle 120 is present within a structure.

The decision unit 107 decides whether the vehicle 120 is present within a structure, based on whether surroundings of the first region are surrounded by the second region in the reference region.

This enables to decide whether the vehicle 120 is present within a structure, based on the first region, and the reference region based on the first region and the second region. Therefore, it becomes possible to accurately decide whether the vehicle 120 is present within a structure.

The analysis unit 106 determines the first region by using a learning model in which the photographed image is input, and region information for dividing into each region included in the photographed image is output.

This enables to decide whether the vehicle 120 is present within a structure, based on the first region, by determining, from the photographed image, the first region being a region associated with the sky. Therefore, it becomes possible to accurately decide whether the vehicle 120 is present within a structure.

A learning model is one of a plurality of learning models according to an attribute of a road. The analysis unit 106 determines the first region by using the learning model, among the plurality of learning models, according to an attribute of a road along which the vehicle 120 travels.

This enables to determine the first region by using the learning model according to an attribute of a road along which the vehicle 120 travels, and therefore, it is possible to more accurately decide the first region. Then, it is possible to decide whether the vehicle 120 is present within a structure, based on the accurately decided first region. Therefore, it becomes possible to more accurately decide whether the vehicle 120 is present within a structure.

### Modification Example 1

In the example embodiment 1, an example in which the analysis unit 106 determines a reference region has been described. However, the analysis unit 106 may not determine a reference region.

In the present modification example, the decision unit 107 may decide whether the vehicle 120 is present within a structure, based on a ratio occupied by a first region in the entirety of a photographed image, and a predetermined threshold value. Specifically, for example, the decision unit 107 decides that the vehicle 120 is present within a structure, in a case where a ratio occupied by the first region is equal to or less than the threshold value, and decides that the vehicle 120 is not present within the structure, in a case where a ratio occupied by the first region is more than the threshold value.

Further, for example, the decision unit 107 may decide whether the vehicle 120 is present within a structure, based on whether surroundings of the first region are surrounded by a second region including a road, a structure, an obstacle, and the like. Specifically, for example, the decision unit 107 decides that the vehicle 120 is present within a structure, in a case where surroundings of the first region are surrounded by the second region in the reference region, and decides that the vehicle 120 is not present within the structure, in a case where surroundings of the first region are not surrounded by the second region in the reference region.

Also according to the present modification example, it is possible to decide whether the vehicle 120 is present within a structure, based on a first region, by deciding, from a photographed image, the first region being a region associated with the sky. Therefore, it becomes possible to accurately decide whether the vehicle 120 is present within a structure.

### Modification Example 2

In the example embodiment 1, an example in which the analysis unit 106 determines a second region has been described. However, the analysis unit 106 may not determine a second region, and may determine, as a reference region, a region above a position associated with a road in a photographed image.

In the present modification example, for example, similarly to the example embodiment 1, the decision unit 107 may decide whether a vehicle 120 is present within a structure, based on a ratio occupied by the first region in the reference region.

Further, for example, the decision unit 107 may decide whether the vehicle 120 is present within a structure, based on whether surroundings of the first region are surrounded by the reference region. Herein, a fact that surroundings of the first region are surrounded by the reference region means that the second region is present above the first region and on a side of the first region. Specifically, for example, the decision unit 107 may decide that the vehicle 120 is present within a structure, in a case where surroundings of the first region are surrounded by the reference region, and decide that the vehicle 120 is not present within the structure, in a case where surrounding of the first region are not surrounded by the reference region.

Also according to the present modification example, it is possible to decide whether the vehicle 120 is present within a structure, based on the first region, by deciding, from a photographed image, the first region being a region associated with the sky. Therefore, it becomes possible to accurately decide whether the vehicle 120 is present within a structure.

### Example Embodiment 2

In the example embodiment 1, an example in which decision is made as to whether a vehicle 120 is present within a structure by using one photographed image has been described.

However, decision may be made as to whether the vehicle 120 is present within a structure by using a time-series photographed image, specifically, a plurality of photographed images. In the present example embodiment, an example in which decision is made as to whether the vehicle 120 is present within a structure by using a time-series photographed image is described.

A vehicle according to an example embodiment 2 includes a travel environment decision apparatus 200 according to the example embodiment 1 in place of the travel environment decision apparatus 100 according to the example embodiment 1. Except for this point, a vehicle according to the present example embodiment may be configured similarly to the vehicle according to the example embodiment 1.

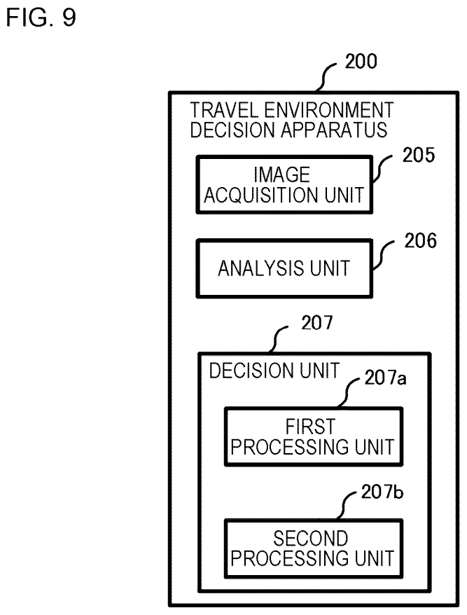

FIG. 9 is a diagram illustrating a functional configuration example of the travel environment decision apparatus 200 according to the present example embodiment. The travel environment decision apparatus 200 functionally includes an image acquisition unit 205, an analysis unit 206, and a decision unit 207.

The image acquisition unit 205 acquires a time-series photographed image from a photographing apparatus 121.

The analysis unit 206 performs analysis processing with respect to each time-series photographed image acquired by the image acquisition unit 205, and determines various regions included in the each photographed image. For example, the analysis unit 206 determines a first region, a second region, and a reference region.

Similarly to the decision unit 107 according to the example embodiment 1, the decision unit 207 decides whether a vehicle is present within a structure, based on the reference region and the first region determined by the analysis unit 206.

As illustrated in FIG. 9, the decision unit 207 according to the present example embodiment includes a first processing unit 207a and a second processing unit 207b.

The first processing unit 107a decides whether each time-series photographed image is a structure-inside image, based on the first region determined in each photographed image by the analysis unit 206. The structure-inside image is an image photographed within a structure.

The second processing unit 207b decides whether a vehicle is present within a structure, based on a decision result of the first processing unit 207a regarding each time-series photographed image.

Each of the image acquisition unit 205, the analysis unit 206, and the decision unit 207 may be configured substantially similarly to the image acquisition unit 105, the analysis unit 106, and the decision unit 107 according to the example embodiment 1 except for the above-described point.

The travel environment decision apparatus 200 according to the present example embodiment may be physically configured similarly to the travel environment decision apparatus 100 according to the example embodiment 1.

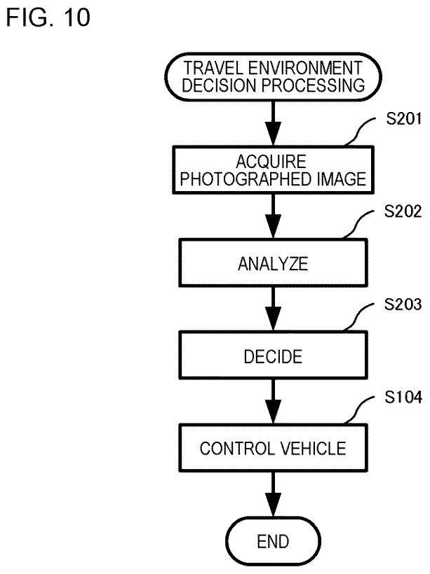

FIG. 10 is a flowchart illustrating one example of travel environment decision processing according to the present example embodiment. The travel environment decision processing according to the present example embodiment includes steps S201 to S103 in place of steps S101 to S103 in the travel environment decision processing according to the example embodiment 1.

The image acquisition unit 205 acquires a plurality of photographed images generated in the photographing apparatus 121 (step S201).

The analysis unit 206 analyzes each photographed image acquired in step S201 (step S202). A content of analysis processing to be performed with respect to each photographed image in step S202 may be similar to analysis processing to be performed with respect to a photographed image in step S102 according to the example embodiment 1.

The decision unit 207 decides whether the vehicle 120 is present within a structure, based on a reference region and a first region determined in step S202 (step S203).

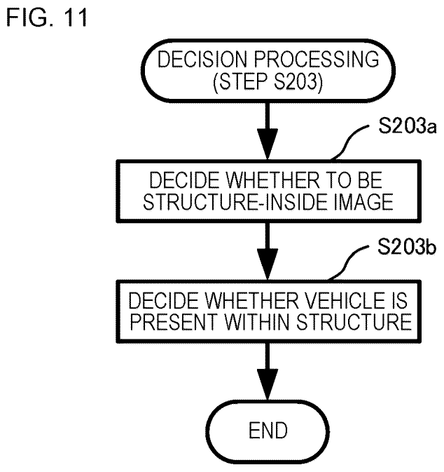

FIG. 11 is a flowchart illustrating a detailed example of decision processing (step S203) according to the present example embodiment.

The first processing unit 207a decides whether each time-series photographed image is a structure-inside image, based on the first region determined for each photographed image in step S202 (step S203a).

The second processing unit 207b decides whether the vehicle is present within a structure, based on a decision result in step S203 regarding each time-series photographed image (step S203b).

Specifically, for example, in a case where a photographed image equal to or more than a predetermined threshold value is decided to be a structure-inside image among a predetermined number of timewise sequential photographed images, the second processing unit 207b decides that the vehicle is present within a structure. Further, in a case where a photographed image less than the threshold value is decided to be a structure-inside image among the predetermined number of timewise sequential photographed images, the second processing unit 207b decides that the vehicle is not present within the structure.

For example, some of the predetermined number of photographed images may be erroneously decided in step S203a as to whether the photographed image is a structure-inside image. In the present example embodiment, decision is made as to whether the vehicle is present within a structure, based on whether a photographed image decided to be a structure-inside image among the predetermined number of timewise sequential photographed images is equal to or more than the threshold value. This enables to accurately decide whether the vehicle is present within a structure, even in a case where erroneous decision is made in step S203a regarding some of photographed images.

### Advantageous Effect

According to the present example embodiment, the image acquisition unit 205 acquires a time-series photographed image. The analysis unit 206 performs analysis processing with respect to each time-series photographed image, and determines a first region in the each photographed image.

The decision unit 207 includes the first processing unit 207a and the second processing unit 207b. The first processing unit 207a decides whether the each time-series photographed image is a structure-inside image photographed within a structure, based on the first region determined in the each photographed image. The second processing unit 207b decides whether the vehicle is present within a structure, based on a decision result of the first processing unit 207a regarding the each time-series photographed image.

As described above, this enables to accurately decide whether a vehicle is present within a structure, even in a case where erroneous decision is made in step S203a regarding some of photographed images. Therefore, it becomes possible to accurately decide whether the vehicle is present within a structure.

In the foregoing, example embodiments according to the present invention have been described with reference to the drawings, however, these are examples of the present invention, and various configurations other than the above can also be adopted.

Further, in a plurality of flowcharts used in the above description, a plurality of processes (pieces of processing) are described in order, however, the order of execution of processes to be performed in each example embodiment is not limited to the order of description. In each example embodiment, the illustrated order of processes can be changed within a range that does not adversely affect a content. Further, the above-described example embodiments can be combined, as far as contents do not conflict with each other.

A part or all of the above-described example embodiments may also be described as the following supplementary notes, but is not limited to the following.
1. A travel environment decision apparatus including:
   an image acquisition unit that acquires a photographed image to be acquired by photographing by a photographing apparatus installed in a vehicle;
   an analysis unit that performs analysis processing with respect to the photographed image, and determines a first region being a region associated with the sky in the photographed image; and
   a decision unit that decides whether the vehicle is present within a structure, based on the first region.
2. The travel environment decision apparatus according to supplementary note 1, wherein
   the analysis unit further determines a reference region in which a predetermined criterion is satisfied in the photographed image, and
   the decision unit decides whether the vehicle is present within a structure, based on the reference region and the first region.
3. The travel environment decision apparatus according to supplementary note 2, wherein
   the reference region is a region above a position associated with a road in the photographed image.
4. The travel environment decision apparatus according to supplementary note 3, wherein
   the position associated with a road is a position of a vanishing point on a road in the photographed image.
5. The travel environment decision apparatus according to any one of supplementary notes 2 to 4, wherein
   the analysis unit performs analysis processing with respect to the photographed image, determines a second region being a region associated with a subject of a predetermined type other than the sky in the photographed image, and determines, as the reference region, the first region and the second region, in a region above a position associated with a road in the photographed image.
6. The travel environment decision apparatus according to supplementary note 5, wherein
   the second region includes a region associated with at least one of an obstacle and a structure.
7. The travel environment decision apparatus according to any one of supplementary notes 2 to 6, wherein
   the decision unit decides whether the vehicle is present within a structure, based on a ratio occupied by the first region in the reference region.
8. The travel environment decision apparatus according to supplementary note 5 or 6, wherein
   the decision unit decides whether the vehicle is present within a structure, based on whether surroundings of the first region are surrounded by the second region in the reference region.
9. The travel environment decision apparatus according to any one of supplementary notes 1 to 8, wherein
   the analysis unit determines the first region by using a learning model in which the photographed image is input, and region information for dividing into each region included in the photographed image is output.
10. The travel environment decision apparatus according to supplementary note 9, wherein
   the learning model is one of a plurality of learning models according to an attribute of a road, and
   the analysis unit determines the first region by using the learning model, among the plurality of learning models, according to an attribute of a road along which the vehicle travels.
11. The travel environment decision apparatus according to any one of supplementary notes 1 to 10, wherein
   the image acquisition unit acquires the photographed image of time series,
   the analysis unit performs analysis processing with respect to the each time-series photographed image, and determines the first region in the each photographed image, and
   the decision unit includes
   a first processing unit that decides whether the each time-series photographed image is a structure-inside-image photographed within a structure, based on the first region determined in the each photographed image, and
   a second processing unit that decides whether the vehicle is present within a structure, based on a decision result of the first processing unit regarding the each time-series photographed image.
12. A vehicle including:
   the travel environment decision apparatus according to any one of supplementary notes 1 to 11; and
   the photographing apparatus that is installed in the vehicle, and generates the photographed image by photographing.
13. The vehicle according to supplementary note 12, further including a vehicle control unit that is installed in the vehicle, and controls the vehicle.
14. A travel environment decision method including, by a computer:
   acquiring a photographed image to be acquired by photographing by a photographing apparatus installed in a vehicle;
   performing analysis processing with respect to the photographed image, and determining a first region being a region associated with the sky in the photographed image; and deciding whether the vehicle is present within a structure, based on the first region.
15. A storage medium storing a program for causing a computer to execute:
   acquiring a photographed image to be acquired by photographing by a photographing apparatus installed in a vehicle;
   performing analysis processing with respect to the photographed image, and determining a first region being a region associated with the sky in the photographed image; and deciding whether the vehicle is present within a structure, based on the first region.
16. A program for causing a computer to execute:
   acquiring a photographed image to be acquired by photographing by a photographing apparatus installed in a vehicle;
   performing analysis processing with respect to the photographed image, and determining a first region being a region associated with the sky in the photographed image; and deciding whether the vehicle is present within a structure, based on the first region.

### Reference Signs List

100, 200 Travel environment decision apparatus
105,205 Image acquisition unit
106, 206 Analysis unit
107, 207 Decision unit
120 Vehicle
121 Photographing apparatus
122 Vehicle control apparatus
207a First processing unit
207b Second processing unit

What is claimed is:

1. A travel environment decision apparatus comprising:
a memory configured to store instructions; and
a processor configured to execute the instructions to:
acquire a photographed image captured by a photographing apparatus installed in a vehicle;
perform analysis processing with respect to the photographed image,
determine a first region being a region associated with a sky in the photographed image; and
decide whether the vehicle is present within a structure, based on the first region.

2. The travel environment decision apparatus according to claim 1, wherein
the processor configured to further execute the instructions to:
determine a reference region in which a predetermined criterion is satisfied in the photographed image, and
whether the vehicle is present within the structure is decided, based on the reference region and the first region.

3. The travel environment decision apparatus according to claim 2, wherein
the reference region is a region above a position associated with a road in the photographed image.

4. The travel environment decision apparatus according to claim 3, wherein
the position associated with the road is a position of a vanishing point on the road in the photographed image.

5. The travel environment decision apparatus according to claim 2, wherein
the analysis processing with respect to the photographed image further includes determining a second region being a region associated with a subject of a predetermined type other than the sky in the photographed image, and determining, as the reference region, the first region and the second region, in a region above a position associated with the road in the photographed image.

6. The travel environment decision apparatus according to claim 5, wherein
the second region includes a region associated with at least one of an obstacle and a structure.

7. The travel environment decision apparatus according to claim 2, wherein
whether the vehicle is present within the structure is decided, based on a ratio occupied by the first region in the reference region.

8. The travel environment decision apparatus according to claim 5, wherein
the decision unit decides whether the vehicle is present within the structure is decided, based on whether surroundings of the first region are surrounded by the second region in the reference region.

9. The travel environment decision apparatus according to claim 1, wherein
the first region is determined by using a learning model in which the photographed image is input, and region information for dividing into each region included in the photographed image is output.

10. The travel environment decision apparatus according to claim 9, wherein
the learning model is one of a plurality of learning models according to an attribute of a road, and
the first region is determined by using the learning model, among the plurality of learning models, according to an attribute of a road along which the vehicle travels.

11. The travel environment decision apparatus according to claim 1, wherein
the processor configured to execute the instructions to:
acquire time-series photographed images including the photographed image,
determine the first region in each of the time-series photographed images by performing the analysis processing with respect to each of the time-series photographed images,
decide whether each of the time-series photographed images is a structure-inside image photographed within a structure, based on the first region determined in each of the time-series photographed images, and
decide whether the vehicle is present within the structure, based on a decision result regarding each of the time-series photographed images.

12. A vehicle comprising:
the travel environment decision apparatus according to claim 1; and
the photographing apparatus that is installed in the vehicle to capture the photographed image.

13. The vehicle according to claim 12, wherein
the processor configured to further execute the instructions to:
control the vehicle.

14. A travel environment decision method comprising,
by a computer:
acquiring a photographed image to be acquired by photographing by a photographing apparatus installed in a vehicle;
performing analysis processing with respect to the photographed image, and determining a first region being a region associated with a sky in the photographed image; and
deciding whether the vehicle is present within a structure, based on the first region.

15. A non-transitory computer readable medium storing a program for causing a computer to execute:
acquiring a photographed image to be acquired by photographing by a photographing apparatus installed in a vehicle;
performing analysis processing with respect to the photographed image, and determining a first region being a region associated with a sky in the photographed image; and
deciding whether the vehicle is present within a structure, based on the first region.
